(19) United States
(12) Patent Application Publication
(10) Pub. No.: US 2004/0217182 A1
(43) Pub. Date: Nov. 4, 2004

(54) Integrated furnace control board and method

(75) Inventors: David L. St. Jean, Chepachet, RI (US); Xun Li, Shrewsbury, MA (US); James E. Kuch, Strongsville, OH (US); Patrick J. Flaherty, Quincy, MA (US); Christina K. Smith, Hudson, MA (US); Stephen S. Johnson, Attleboro, MA (US)

Correspondence Address: TEXAS INSTRUMENTS INCORPORATED, 34 FOREST STREET, MS 20-21, ATTLEBORO, MA, 02703, US

(73) Assignee: TEXAS INSTRUMENTS INCORPORATED

(21) Appl. No.: 10/830,768

(22) Filed: Apr. 23, 2004

Related U.S. Application Data
(60) Provisional application No. 60/466,285, filed on Apr. 29, 2003.

(51) Int. Cl. H05B 1/02

(52) U.S. Cl. 237/2 A

(57) ABSTRACT

An electronic control (8) is shown adapted for use with gas furnaces which controls function and speed(s) of an induced draft motor (44), an igniter source (13), gas valve(s) (14), and function and speed(s) of a blower motor (21) based on inputs from a room thermostat, various sensor and safety devices, and proper sequence/position/change of position timing of these inputs. The control is capable of detecting and saving for recall specific errors and faults that occur while in service. The control can communicate warnings, faults, and errors, as well as safety lock-out conditions in various ways including a Light Emitting Diode (LED) (9), as a generic fault condition through a set of dry contacts (45a), or as very specific fault conditions through a communications interface (H4). The control provides other benefits to the installer, occupants of the space, and service technicians including selectable igniter warm-up times, user selectable fan On speed and blower delay-off times.

### RELATED APPLICATIONS

Benefit is claimed under 35 U.S.C. Section 119(e) (1) of U.S. Provisional Application No. 60/466,285, filed Apr. 29, 2003. application Ser. No. ______ (Attorney Docket Nos. A42237, A42238) filed of even date and assigned to the assignee of the present invention contain subject matter related to that contained herein.

### FIELD OF THE INVENTION

This invention relates generally to furnace controls and more particularly to enhancements for existing integrated ignition control boards that can benefit the furnace equipment OEM, the equipment installer, the homeowner, business owner and occupants of the space conditioned by the equipment with the control enhancements, as well as service technicians who may have to work on the equipment.

### BACKGROUND OF THE INVENTION

Conventional furnace controls have several limitations which the instant invention addresses. Integrated or combined ignition/fan controls are common in the heating, ventilating and air conditioning (HVAC) industry. It is common for these types of controls to have some type of limited diagnostic capabilities, which typically exist as an error code being translated as a blink code on an LED (light emitting diode), or a seven segment display. Until recently, most of these error codes were only shown while the actual error was happening, or while the furnace lock-out condition persisted. In both cases this only occurred when there was power connected to the control board without interruption. In other words, a loss of power to such control board results in a reset of the control and loss of any error information. So, when a repair technician shows up to evaluate a problem, often times the home or business owner has already shut power down to the unit, which eliminates the error code without the possibility of recall. The service technician, upon arrival to the site, may also remove a metal panel which is often connected to a power disconnect switch. If this is done before looking through a site-glass for any applicable error codes (if a site-glass is even provided on the access door), again the potentially valuable information of the error code would be lost. Unless the error duplicates itself immediately upon test by the service technician, a lengthy trial and error period may be required to finally find and then fix the problem. Over the last couple of years, the use of EEPROM and/or other non-volatile memory within a microprocessor has been used to store these error codes, such that they are displayed even after a power loss and control reset, or are otherwise recallable, such as through the use of an error recall mechanism. In some cases, even multiple errors are recorded in the EEPROM or other non-volatile memory, such that a history of faults can be saved and recalled. This type of error code information is extremely valuable to service technicians. Instead of an on-site service technician waiting for a problem to re-occur, or trouble shooting a broken furnace through a long process of trial and error techniques without any past history, the furnace control can now direct the technician in the direction of the actual cause, and at least minimize the amount of trouble shooting required. However, not knowing when an error occurred can still limit the effectiveness of the error code diagnosis. It is an object of the invention to provide a control with an improved diagnostic capability to overcome the noted limitation of the prior art.

Typically a hot surface igniter (HSI) is used in gas furnaces. One of the requirements for successful ignition in the case of a hot surface igniter is to ensure that it reaches the combustion temperature of the gas that it is intended to ignite, before the gas valve opens. There are different types of igniter materials (silicon carbide and silicon nitride to name the commonly used ones today), that within material types or across material types have different warm-up times, and/or different voltage requirements to ensure the proper igniter temperature and igniter performance. Today, the HSI operating parameters of a control board are tied to a specific igniter type. For example, a control that turns the HSI on for a 17 second igniter warm-up period prior to opening the gas valve will work adequately with an igniter that requires 17 seconds to reach the gas ignition temperature, but it will not work with an igniter that requires a 34 second warm up time. Conversely, this same control with a 17 second warm-up parameter could be utilized with an igniter that only required a 5 second warm-up time (in order to reach combustion temperature); however, the benefit of the faster igniter warm-up period will not be realized, and the additional on-time of applied voltage may actually harm the intended useful life of the 5 second igniter. It is an object of the invention to provide a control which overcomes this noted limitation of the prior art.

It is common practice today for wall thermostats to contain a fan switch with the two positions of ON, and AUTO. In AUTO mode, the furnace blower will come on and shut off automatically as is appropriate and previously programmed, in response to a call for heating or cooling. When however the fan switch is placed in the ON position, then 24 VAC (typically present on the R control terminal) is switched by the wall thermostat and is applied to the G control terminal, also known as the fan terminal. In current systems, when 24 VAC is applied to the G terminal, then the control will energize a single pre-selected motor tap, or motor speed. Removal of 24 VAC at G (switching fan to AUTO) will result in a corresponding de-energization of the blower motor. The limitation of this approach is that there is no choice in the amount of airflow provided when the fan setting is turned ON, despite it being commonplace to use multi-tap or multi-speed motors in these gas furnaces. It is an object of the invention to provide a control permitting such choice.

Yet another prior art limitation relates to blower delay-on and blower delay-off time. Presently, in order to attempt to improve system efficiency, and/or improve occupant comfort, integrated ignition controls will often have a means to adjust blower delay-on and/or blower delay-off times for heating and/or cooling modes. For instance, these selectable time delays either delay the turn-on time of a blower to allow a heat exchanger to warm up before blowing cold air into an area expecting warm air, and/or delay the turn-off time of the blower to extract the remaining heat (or cold) from the heat exchanger (or evaporator) after the thermostat has been satisfied and ignition stops (or the compressor stops in cooling mode) to improve efficiency and comfort. Depending on the volume of the ductwork, the insulation surrounding the ductwork, the use of natural gas versus liquefied propane, the ambient temperature surrounding the furnace cabinet and ductwork when in the off and on period, etc., these blower on-delays and off-delays should be adjusted to ensure the correct balance of efficiency, occupant comfort, and equipment cycle life. The selection criteria available on today's common controls typically allow variations with 15 second deltas for blower on-delays, and 30 to 60 second deltas for blower off-delays. The number of selections and the resulting air temperature exiting room registers between fixed time offerings is typically limited between 2 and 4, due to the control board component costs, board space and/or software I/O required to handle these additional selectable times. It is an object of the invention to provide a control to overcome this limitation.

Still another limitation of the prior art controls relates to serially connected safety devices and when a fault occurs in one of the devices the problem of distinguishing which type of fault occurred and which safety device actually tripped. In today's gas furnaces, it is common to send a low voltage signal (for instance 24 VAC) out from the control through the safety device switch, and to look for a return voltage back at the control. This allows the determination of the safety switch as being in the open or closed position and is commonly used for pressure switches (to ensure adequate induced air flow through the exhaust), for high limit switches (to sense when excessive heat is present around the heat exchanger), for roll-out switches (to sense when the flame is not in its proper location), and the like. In some gas furnaces today, each of these different sensor types have their own separate voltage input and output lines back into the control board. As such, individual error codes can be assigned when the wrong switch position occurs at the wrong time, and subsequent furnace operations such as turning the main blower and/or the induced draft blower on in response to the error can take place as desired. In other cases, safety devices may be serially connected, e.g., an upper limit switch(es) is connected in series with the flame roll-out switch, and only a single error code, or post error furnace response is possible. A furnace OEM may choose to place several sensors in series with each other either to save wiring cost, save space within the connector for other inputs or outputs, or to conserve (I/O (inputs/outputs) on the control microprocessor. A fault in either one of these will result in the same error code, and the same equipment shut-down and post shut-down protocol. In actuality, the furnace OEM might want different shut-down and post shut-down protocols if they could distinguish which type of fault occurred and which safety thermostat actually tripped. It is another object of the invention to provide a control that has the capability of overcoming this limitation.

### SUMMARY OF THE INVENTION

It is an object of the present invention to provide a control which overcomes the prior art limitations noted above. Another object of the invention is the provision of an integrated furnace ignition control which includes improved diagnostic capability. Yet another object of the invention is the provision of an integrated furnace ignition control which allows for readily adapting the control for use with various HSI devices and readily selecting optimum fan speeds and blower delay times for a given installation. Still another object of the invention is the provision of a control which identifies which position of a multiple input selection is used using a low cost method and apparatus. Another object of the invention is the provision of a control in which serially connected safety devices can be distinguished from one another and appropriate fault codes assigned.

Briefly, according to a feature of the invention, a time stamp associated with the generation of an error code and the error code, are both saved in non-volatile memory for later recall. As a result, when the errors are retrieved for diagnostic purposes, the time stamp can also be used to improve error analysis by determining whether multiple errors are occurring repeatedly, during a particular part of the day, as a result of an immediately preceding error, and the like. This saves the need for a separate external system or external data logger, as is discussed in U.S. Pat. Nos. 5,515,297 and 5,761,092. This also makes it possible to link the time of an error to a condition external to the furnace, such as weather, if found to be appropriate. For instance, if a pressure switch keeps opening during an ignition cycle, and the time stamp corresponds to a time period in which extremely high winds occurred, then the permanent fix might require a change to the outside exhaust baffle, versus a change of the furnace pressure switch or control board. Likewise, if the control goes into a 1 hour lock-out due to a recycle or retry condition, an associated time stamp could help confirm that the error(s) occurred at the same time a thunderstorm came through the area causing low power conditions. With an associated time stamp in accordance with the invention, service technicians can link error code occurrence to certain brief weather phenomenon known to interfere with the proper operation of these electronic controls, in order to prevent unnecessary replacement of furnace components and/or the electronic control. This also helps to ensure that the real problem gets diagnosed and corrected during the first service call. If power is removed from the control board on purpose or by accident, the errors and time stamps will not be lost, and will be retrievable once power is restored to the board. This saving of error codes and time stamps can be a single code, an infinite number of codes, or more practically a fixed number of codes, n, above which the first error code saved will be bumped to make room for error number n+1, the second error code saved will be replaced by n+2, and the like (only in the event that the error event recorder buffer n is exceeded).

According to another feature of the invention, different igniter parameters can be selected by the simple change of a jumper block position, a dip-switch block setting, and/or any other similar selection mechanism to allow a choice to be made between a plurality of possible igniters, including warm-up times, material types, or the like. The ability to select the appropriate parameters to correctly operate the HSI allows an OEM to use a single control board with multiple types of igniters on their various grades of furnace lines, allows a service parts company to carry a single control board (assuming other critical timings to be equal, except for the igniter warm-up time), and allows future igniter upgrades as the home owner desires, and/or as technology improvements occur, without the need to replace the entire control board.

According to another feature, an additional programmable setting is provided. The programmable value resides in non-volatile memory so that it will not be erased in the event of a power loss or control board reset, and will be recalled and used in the ignition timing sequence when the programmed position is chosen. Again, this programmable feature could be enabled to trigger an additional warm-up time, as a means to adjust parameters required to switch from silicon carbide to silicon nitride or some other igniter material, or the like.

According to another feature of the invention, different main blower fan speeds can be selected by the simple change of a jumper block position, a dip-switch block setting, and/or any other similar selection mechanism to allow a choice to be made between a plurality of main blower motor taps. If the wall thermostat fan switch is turned ON, then instead of turning on a single pre-selected blower speed (which does not satisfy all conditions), the installer or home/business owner has the option to direct blower motor power to any of the available motor tap speeds that are connected to active blower outputs on the control board. This gives the option of having a very low fan blower speed, to just keep air circulating to avoid hot or cold zones while the furnace is in-between active heating cycles, but avoid a chill in the air during heating season; or to have a higher main blower speed to force more air turbulence to create a condition of higher skin evaporation in the summer time, when the system is in-between active cooling cycles. As suggested, this fan ON speed can also be adjusted on the control board as different needs are encountered through different seasons. According to a feature of this invention, a separate jumper position is provided in which the setting is identified as a Programmable setting. The programmable value resides in non-volatile memory so that it will not be erased in the event of a power loss or control board reset, and can be recalled and used whenever the jumper is in the PROG position, the thermostat fan switch is turned ON, and other heating or cooling blower fan speeds are not overriding the fan ON position. This allows a default fan speed position to be set for a particular application without the need to physically move the jumper to the desired position. This could be useful to an OEM, where they could automatically set a particular fan speed default at the end of their manufacturing line through a communications interface by using an external device (laptop, PDA, or other comparable device). Or, it might also be useful to the occupant of the conditioned space; as when in the programmable setting, they could set the particular blower motor speed default desired for the upcoming season through the communications interface with the control board by using an external device (laptop, PDA, communicating thermostat, or other comparable device) without having to physically change the position of the selector if different blower motor speed settings are desired for different seasons.

According to another feature of the invention, a jumper position, dip-switch setting, and/or any other similar position is added to the choice of possibilities provided in which the blower delay setting is identified as a Programmable setting. When the PROG setting is chosen, the OEM or a knowledgeable technician can utilize the communications interface and an external device (laptop, PDA, or other comparable device) in order to place the desired programmable parameter into non-volatile memory. The use of this PROG position for blower delays may be limited to a single blower delay-off selection for heating, and/or may include any other OEM desired blower delays including blower delay-off for cooling or fan, and/or blower delay-on for heating, cooling, or fan conditions. Depending on the OEM desired blower delays, if the heating, cooling, or fan running had one of these selectable blower delays implemented, and the jumper was in the PROG position, then the blower on-delay or blower off-delay would either turn on or off in accordance with the programmed non-volatile memory location value.

According to yet another feature of the invention, means is provided to take advantage of two different types of switches commonly used for the high limit and flame roll-out switches, such that their reset characteristics can be evaluated to provide individual error codes and tailor post shut-down protocols, once the error is correctly identified. Across the gas furnace industry, high limit switches or “stat on stilts” as they are sometimes called, are normally closed 1/2 inch thermostats with automatic reset. Conversely, the flame roll-out switches are normally closed 1/2 inch thermostats with a manual reset feature. By taking advantage of the difference between the automatic and manual resetting devices, the control can distinguish between the devices and the type of error that has occurred, and then act accordingly with specific shut-down and post shut-down protocols per individual error type.

Additional objects, advantages and features of the novel and improved integrated furnace control and method of this invention will be set forth in part in the description which follows and in part will be obvious from the description.

### BRIEF DESCRIPTION OF THE DRAWINGS

The accompanying drawings, which are incorporated in and constitute a part of the specification, illustrate preferred embodiments of the invention and, together with the description, serve to explain the objects, advantages and principles of the invention. In the drawings:

FIG. 1 is a schematic diagram of a control board and furnace system components and their connection to the board in accordance with the invention;

FIG. 2 is an operational diagram showing an Elapsed Time Clock and associated components which, in the preferred embodiment, reside in the microprocessor of the control;

FIG. 3 is a schematic diagram showing a microprocessor used in the furnace control of the invention along with jumper blocks and their connections;

FIG. 4 is a schematic diagram showing one of the FIG. 2 jumper blocks along with the microprocessor and associated circuitry;

FIG. 5 is a timing diagram related to the FIG. 4 jumper block; and

FIGS. 6-9 are flow charts relating to the operation of the control in accordance with the invention;

### DETAILED DESCRIPTION OF PREFERRED EMBODIMENTS

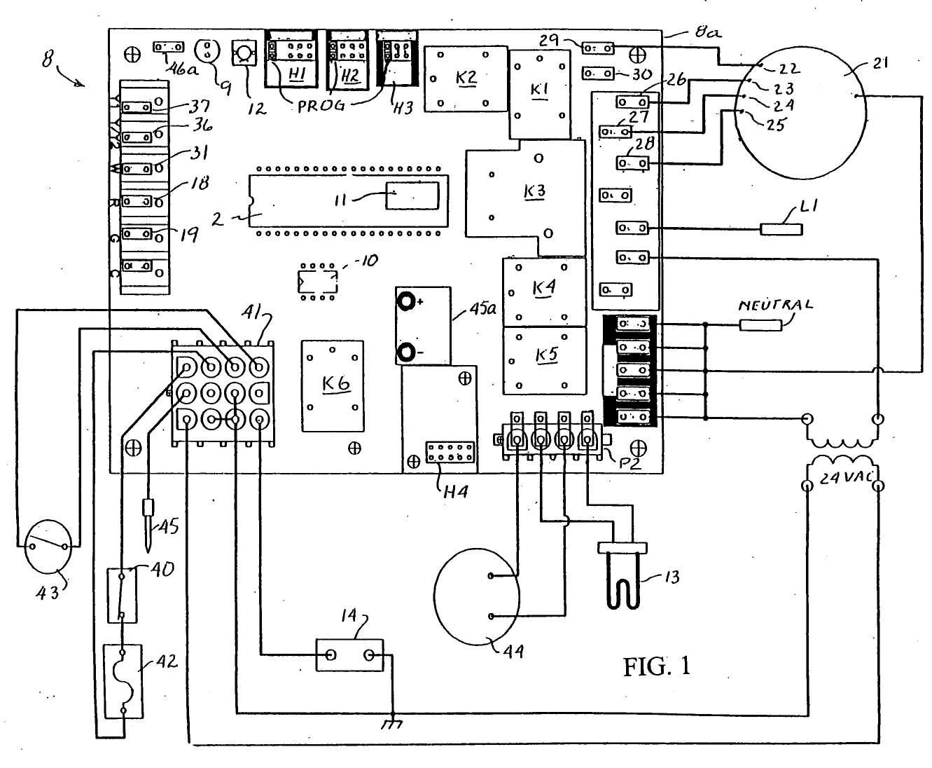

A gas furnace ignition control 8 made in accordance with a preferred embodiment of the invention, along with associated components, shown in FIG. 1 comprises control board 8a on which a microprocessor 2 having non-volatile memory 11 for controlling the various components of the system is mounted. Low voltage thermostat quick connects 18, 19, 31, 36, 37 for signals R, G, W, Y/Y2 and Y1 are mounted on the board for providing inputs to the microprocessor along with a quick connect for common C. A connector 41 provides connections for a pressure switch 43, serially connected limit switch 40 and roll-out switch 42, flame probe 45, gas valve 14 and a 24 volt transformer. Another connector P2 provides connections for induced draft motor 44 and igniter 13. A main blower motor 21 is provided with motor speed taps 22, 23, 24, 25, respectively, connected to park quick connect 29, lo cool quick connect 26, hi cool quick connect 27 and heat quick connect 28. Park terminals 29 and 30 are dummy terminals used to plug unused motor tap wires to avoid loose hanging wires in the furnace. Line voltage 35 is connected to quick connect L1. A twin quick connect 46a, an LED or status connector 9 and a last error pushbutton switch 12 are also disposed on board 8. The board also includes flame probe current electrodes 45a, relays K1-K6 and jumper boxes H1 for blower delay, H2 for fan speed and H3 for HSI warm-up and H4 for a plug-on communication interface.

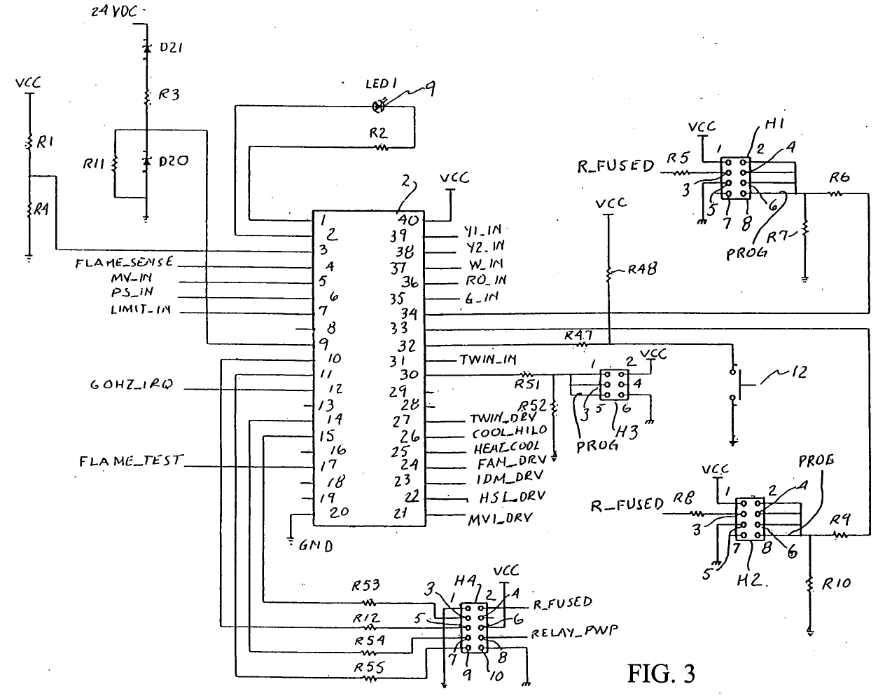

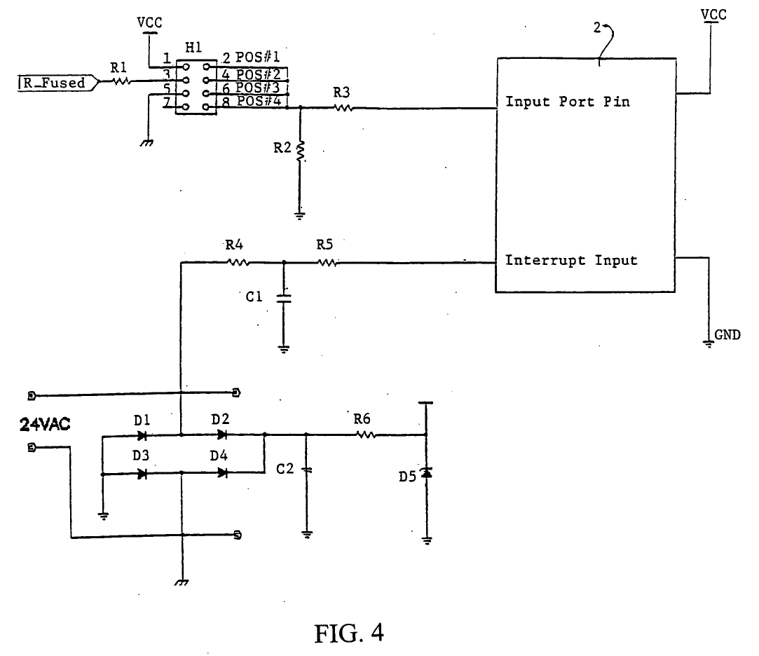

Specific wiring connections of the board mounted components are conventional and will not be shown or described in detail except for those shown in FIGS. 3 and 4 which will be discussed below. An optional component in the form of EEPROM 10 is shown in FIG. 1 in dashed lines and although not used in the described preferred embodiment can be used along with or in place of non-volatile memory 11 of microprocessor 2.

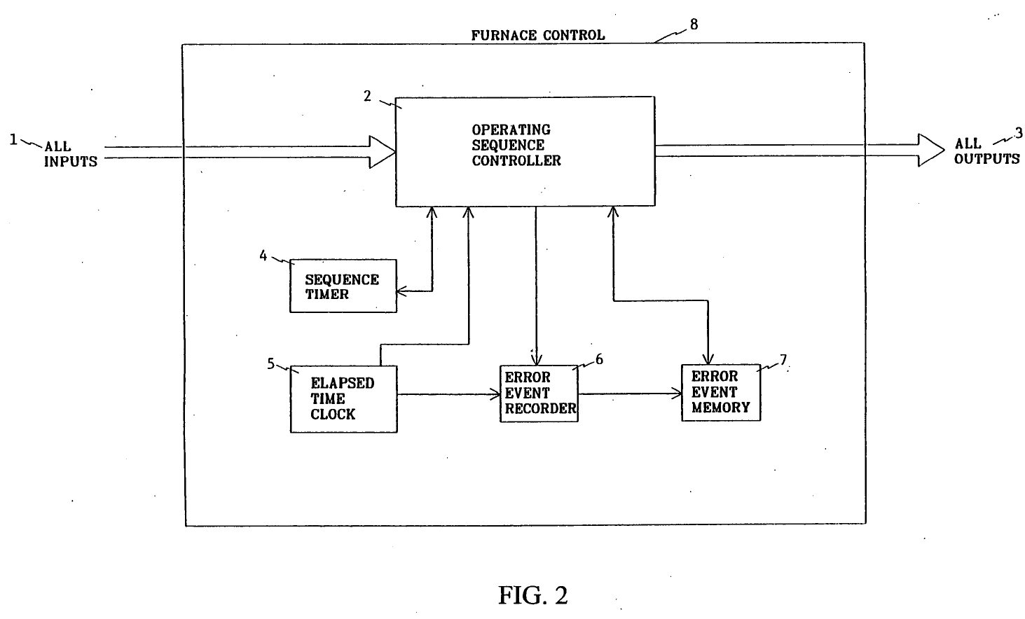

With reference to FIG. 2, integrated furnace control 8 is shown with an elapsed time clock 5 for the purpose of saving past furnace system error events with time stamps. The furnace control 8 monitors all typical furnace inputs 1 which may include the room thermostat, high temperature limit switches, inducer providing switch, flame roll-out, flame sensor, and serial diagnostic data communications input. The furnace control 8 provides control for all furnace outputs 3 which may include the gas valve, igniter, status LED, inducer blower, main blower, and serial diagnostic data communications output. The furnace control 8 also includes a sequence timer 4 to measure time of the furnace's operating sequence such as trial for ignition time, pre-purge time, igniter warm-up time, blower delay time and lock-out time. The sequence timer 4 is reset at the end of the operating sequence and then restarted at the beginning of each operating sequence. The furnace control 8 includes logic circuits and/or software which form an operating sequence controller 2. The operating sequence controller 2 performs the proper operating sequence for the furnace based on the inputs 1, the current outputs 3, and the sequence timer 4. Since the controller 2 controls all furnace operation, it can also detect certain furnace system error conditions such as a high temperature limit trip, broken inducer, broken blower, false flame, and failure to light or sense flame.

The control 8 includes an elapsed time clock 5 that measures the length of time that the furnace control 8 has been powered on since the control was placed into service, or, if desired, clock 5 can contain its own power source and would also measure the length of time since the furnace control 8 was either manufactured and/or placed into service. The clock 5 permanently retains the time and is never reset or erased. The control 8 includes a furnace system error event recorder 6 and an error event memory 7 which is part of non-volatile memory 11, or, as noted above, could be EEPROM 10. When a furnace system error occurs, the sequence controller 2 notifies the error event recorder 6 that a specific error event has occurred. The event recorder 6 then combines the error event data from the sequence controller 2 and adds a time stamp from the elapsed time clock 5 and stores the time stamped error event data in the error event memory 7. The error event memory 7 is implemented as semi-permanent memory so error event data is not lost when the power is removed. The time stamped error data can be retrieved by the sequencer controller 2 for diagnostic purposes. The sequence controller 2 may also erase the error event memory 7. In a control made in accordance with the invention, sequence timer 4, elapsed time clock 5, error event recorder 6 and error event memory 7 are contained within a microprocessor 2 even though for purposes of illustration, FIG. 2 shows these items external to the microprocessor.

The controller is adapted to provide a time stamp for a life span of 30 years using 3 bytes for running time minute storage. The control is adapted to store in non-volatile memory up to n number of error codes along with the relative time stamp for each error code. The elapsed time clock 5 is incremented each minute as long as power is applied to it. In the described embodiment n is selected to be 5. If the error code array fills up, the 6th (n+1) code will overwrite the 1st, the 7th will overwrite the 2nd, and so on, so that the last 5 codes are always stored. A portion of the error code array is designated as the “active error code array”. This active array will indicate the most recent error codes (up to a maximum of 5) which have occurred since the last time errors were cleared. If the last error pushbutton 12 is pressed for longer than ⅕ second but less than 5 seconds, and no thermostat signals are active at the time, the control will sequentially flash, on the status LED 9 the series of active error codes (up to the last 5 since the active error codes were last cleared) starting with the most recent. If there are no stored error codes in the active error code array when last error pushbutton 12 is pressed, the control flashes a corresponding code, e.g., 2 green flashes. Pressing Last Error pushbutton for longer than 5 seconds will clear the active error code array and this cleared condition is shown by flashing another code, e.g., 3 green flashes.

According to the preferred embodiment of the invention, error codes and their associated time stamps are accessible via the serial communications port H4, to be discussed.

In the particular microprocessor used in a control made in accordance with the preferred embodiment, model ATMEGA8518 manufactured by Atmel Corporation, the error codes and associated time stamp are stored in non-volatile memory 11, index locations 13 through 20, shown in Table 1, entitled Error Code Storage. Index locations 21 through 41, Table 2 entitled Floating Time Stamp Storage, contain the memory locations for the running minutes timer, elapsed time clock 5. As noted above, the running minutes for a 30 year period are tracked, requiring a large memory. The values are shifted when using flash ROM since the write cycles are guaranteed for a limited time, e.g., 100K times. As a result, the information is rotated over time into different memory locations.

Index location 59 contains the register for the programmed values that are saved for HSI of jumper block H3 (bytes 3 and 4), blower delay of jumper H1 (bytes 5 and 6) and fan speed of jumper H2 (bytes 7 and 8) to be discussed.

It will be noted from Table 1 with reference to index locations 20 that up to 16 error codes and time stamps are saved. This enables a review of an expanded error event history compared to that shown in the active error code array, i.e., the most recent 5 events.

TABLE 1
Error Code Storage

| Index | Address | 1^{st} Byte | 2^{nd} Byte | 3^{rd} Byte | 4^{th} Byte | 5^{th} Byte | 6^{th} Byte | 7^{th} Byte | 8^{th} Byte |
|---|---|---|---|---|---|---|---|---|---|
| 11 | 0058H | 1^{st} Error | 2^{nd} Error | 3^{rd} Error | 4^{th} Error | 5^{th} Error | 6^{th} Error | 7^{th} Error | 8^{th} Error |
| | | Code | Code | Code | Code | Code | Code | Code | Code |
| | | Checksum | Checksum | Checksum | Checksum | Checksum | Checksum | Checksum | Checksum |
| 12 | 0060H | 9^{th} Error | 10^{th} Error | 11^{th} Error | 12^{th} Error | 13^{th} Error | 14^{th} Error | 15^{th} Error | 16^{th} Error |
| | | Code | Code | Code | Code | Code | Code | Code | Code |
| | | Checksum | Checksum | Checksum | Checksum | Checksum | Checksum | Checksum | Checksum |
| 13 | 0068H | 1^{st} Error | Time | Time | Time | 2^{nd} Error | Time | Time | Time |
| | | Code | Stamp #1 | Stamp #2 | Stamp #3 | Code | Stamp #1 | Stamp #2 | Stamp #3 |
| 14 | 0070H | 3^{rd} Error | Time | Time | Time | 4^{th} Error | Time | Time | Time |
| | | Code | Stamp #1 | Stamp #2 | Stamp #3 | Code | Stamp #1 | Stamp #2 | Stamp #3 |
| 15 | 0078H | 5^{th} Error | Time | Time | Time | 6^{th} Error | Time | Time | Time |
| | | Code | Stamp #1 | Stamp #2 | Stamp #3 | Code | Stamp #1 | Stamp #2 | Stamp #3 |
| 16 | 0080H | 7^{th} Error | Time | Time | Time | 8^{th} Error | Time | Time | Time |
| | | Code | Stamp #1 | Stamp #2 | Stamp #3 | Code | Stamp #1 | Stamp #2 | Stamp #3 |
| 17 | 0088H | 9^{th} Error | Time | Time | Time | 10^{th} Error | Time | Time | Time |
| | | Code | Stamp #1 | Stamp #2 | Stamp #3 | Code | Stamp #1 | Stamp #2 | Stamp #3 |
| 18 | 0090H | 11^{th} Error | Time | Time | Time | 12^{th} Error | Time | Time | Time |
| | | Code | Stamp #1 | Stamp #2 | Stamp #3 | Code | Stamp #1 | Stamp #2 | Stamp #3 |
| 19 | 0098H | 13^{th} Error | Time | Time | Time | 14^{th} Error | Time | Time | Time |
| | | Code | Stamp #1 | Stamp #2 | Stamp #3 | Code | Stamp #1 | Stamp #2 | Stamp #3 |
| 20 | 00A0H | 15^{th} Error | Time | Time | Time | 16^{th} Error | Time | Time | Time |
| | | Code | Stamp #1 | Stamp #2 | Stamp #3 | Code | Stamp #1 | Stamp #2 | Stamp #3 |

TABLE 2
Floating Time Stamp Storage

| Index | Address | 1^{st} Byte | 2^{nd} Byte | 3^{rd} Byte | 4^{th} Byte | 5^{th} Byte | 6^{th} Byte | 7^{th} Byte | 8^{th} Byte |
|---|---|---|---|---|---|---|---|---|---|
| 21 | 00A8H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 1 | Bytes - 1 | Bytes - 2 | Bytes - 2 | Bytes - 3 | Bytes - 3 | Bytes - 4 | Bytes - 4 |
| | | | Checksum | | Checksum | | Checksum | | Checksum |
| 22 | 00B0H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 5 | Bytes - 5 | Bytes - 6 | Bytes - 6 | Bytes - 7 | Bytes - 7 | Bytes - 8 | Bytes - 8 |
| | | | Checksum | | Checksum | | Checksum | | Checksum |
| 23 | 00B8H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 9 | Bytes - 9 | Bytes - 10 | Bytes - 10 | Bytes - 11 | Bytes - 11 | Bytes - 12 | Bytes - 12 |
| | | | Checksum | | Checksum | | Checksum | | Checksum |
| 24 | 00C0H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | timer 1^{st} | Timer 1^{st} |
| | | Bytes - 13 | Bytes - 13 | Bytes - 14 | Bytes - 14 | Bytes - 15 | Bytes - 15 | Bytes - 16 | Bytes - 16 |
| | | | Checksum | | Checksum | | Checksum | | Checksum |
| 25 | 00C8H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 17 | Bytes - 17 | Bytes - 18 | Bytes - 18 | Bytes - 19 | Bytes - 19 | Bytes - 20 | Bytes - 20 |
| | | | Checksum | | Checksum | | Checksum | | Checksum |
| 26 | 00D0H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 21 | Bytes - 21 | Bytes - 22 | Bytes - 22 | Bytes - 23 | Bytes - 23 | Bytes - 24 | Bytes - 24 |
| | | | Checksum | | Checksum | | Checksum | | Checksum |
| 27 | 00D8H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 25 | Bytes - 25 | Bytes - 26 | Bytes - 26 | Bytes - 27 | Bytes - 27 | Bytes - 28 | Bytes - 28 |
| | | | Checksum | | Checksum | | Checksum | | Checksum |
| 28 | 00E0H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 29 | Bytes - 29 | Bytes - 30 | Bytes - 30 | Bytes - 31 | Bytes - 31 | Bytes - 32 | Bytes - 32 |
| | | | Checksum | | Checksum | | Checksum | | Checksum |
| 29 | 00E8H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 33 | Bytes - 33 | Bytes - 34 | Bytes - 34 | Bytes - 35 | Bytes - 35 | Bytes - 36 | Bytes - 36 |
| | | | Checksum | | Checksum | | Checksum | | Checksum |
| 30 | 00F0H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 37 | Bytes - 37 | Bytes - 38 | Bytes - 38 | Bytes - 39 | Bytes - 39 | Bytes - 40 | Bytes - 40 |
| | | | Checksum | | Checksum | | Checksum | | Checksum |
| 31 | 00F8H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 41 | Bytes - 41 | Bytes - 42 | Bytes - 42 | Bytes - 43 | Bytes - 43 | Bytes - 44 | Bytes - 44 |
| | | | Checksum | | Checksum | | Checksum | | Checksum |
| 32 | 0100H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 45 | Bytes - 45 | Bytes - 46 | Bytes - 46 | Bytes - 47 | Bytes - 47 | Bytes - 48 | Bytes - 48 |
| | | | Checksum | | Checksum | | Checksum | | Checksum |
| 33 | 0108H | Running | Running | Running | Running | Running | Running | Running | Running |
| | | Timer 1^{st} | Timer 1^{st} | Timer 1^{st} | Timer 1^{st} | Timer 1^{st} | Timer 1^{st} | Timer 1^{st} | Timer 1^{st} |
| | | Bytes - 49 | Bytes - 49 | Bytes - 50 | Bytes - 50 | Bytes - 51 | Bytes - 51 | Bytes - 52 | Bytes - 52 |
| | | | Checksum | | Checksum | | Checksum | | Checksum |
| 34 | 0110H | Running | Running | Running | Running | Running | Running | Running | Running Timer |
| | | Timer 1^{st} | Timer 1^{st} | Timer 1^{st} | Timer 1^{st} | Timer 1^{st} | Timer 1^{st} | Timer 1^{st} | 1^{st} Bytes - 56 |
| | | Bytes - 53 | Bytes - 53 | Bytes - 54 | Bytes - 54 | Bytes - 55 | Bytes - 55 | Bytes - 56 | Checksum |
| | | | Checksum | | Checksum | | Checksum | | |
| 35 | 0118H | Running | Running | Running | Running | Running | Running | Running | Running Timer |
| | | Timer 1^{st} | Timer 1^{st} | Timer 1^{st} | Timer 1^{st} | Timer 1^{st} | Timer 1^{st} | Timer 1^{st} | 1^{st} Bytes - 60 |
| | | Bytes - 57 | Bytes - 57 | Bytes - 58 | Bytes - 58 | Bytes - 59 | Bytes - 59 | Bytes - 60 | Checksum |
| | | | Checksum | | Checksum | | Checksum | | |
| 36 | 0120H | Running | Running | Running | Running | Running | Running | Running | Running Timer |
| | | Timer 1^{st} | Timer 1^{st} | Timer 1^{st} | Timer 1^{st} | Timer 1^{st} | Timer 1^{st} | Timer 1^{st} | 1^{st} Bytes - 64 |
| | | Bytes - 61 | Bytes - 61 | Bytes - 62 | Bytes - 62 | Bytes - 63 | Bytes - 63 | Bytes - 64 | Checksum |
| | | | Checksum | | Checksum | | Checksum | | |
| 37 | 0128H | Running | Running | Running | Running | Running | Running | Running | Running Timer |
| | | Timer 1^{st} | Timer 1^{st} | Timer 1^{st} | Timer 1^{st} | Timer 1^{st} | Timer 1^{st} | Timer 1^{st} | 1^{st} Bytes - 68 |
| | | Bytes - 65 | Bytes - 65 | Bytes - 66 | Bytes - 66 | Bytes - 67 | Bytes - 67 | Bytes - 68 | Checksum |
| | | | Checksum | | Checksum | | Checksum | | |
| 38 | 0130H | Running | Running | Running | Running | Running | Running | Running | Running Timer |
| | | Timer 1^{st} | Timer 1^{st} | Timer 1^{st} | Timer 1^{st} | Timer 1^{st} | Timer 1^{st} | Timer 1^{st} | 1^{st} Bytes - 72 |
| | | Bytes - 69 | Bytes - 69 | Bytes - 70 | Bytes - 70 | Bytes - 71 | Bytes - 71 | Bytes - 72 | Checksum |
| | | | Checksum | | Checksum | | Checksum | | |
| 39 | 0138H | Running | Running | Running | Running | Running | Running | Running | Running Timer |
| | | Timer 1^{st} | Timer 1^{st} | Timer 1^{st} | Timer 1^{st} | Timer 1^{st} | Timer 1^{st} | Timer 1^{st} | 1^{st} Bytes - 76 |
| | | Bytes - 73 | Bytes - 73 | Bytes - 74 | Bytes - 74 | Bytes - 75 | Bytes - 75 | Bytes - 76 | Checksum |
| | | | Checksum | | Checksum | | Checksum | | |
| 40 | 0140H | Running | Running | Running | Running | Running | Running | Running | Running Timer |
| | | Timer 1^{st} | Timer 1^{st} | Timer 1^{st} | Timer 1^{st} | timer 1^{st} | Timer 1^{st} | Timer 1^{st} | 1^{st} Bytes - 80 |
| | | Bytes - 77 | Bytes - 77 | Bytes - 78 | Bytes - 78 | Bytes - 79 | Bytes - 79 | Bytes - 80 | Checksum |
| | | | Checksum | | Checksum | | Checksum | | |
| 41 | 0148H | Running | Running | Running | Running | Running | Running | Running | Running Timer |
| | | Timer 1^{st} | Timer 1^{st} | Timer 1^{st} | Timer 1^{st} | Timer 1^{st} | Timer 1^{st} | Timer 1^{st} | 1^{st} Bytes - 84 |
| | | Bytes - 81 | Bytes - 81 | Bytes - 82 | Bytes - 82 | Bytes - 83 | Bytes - 83 | Bytes - 84 | Checksum |
| | | | Checksum | | Checksum | | Checksum | | |
| 42-51 | 0150H- | Reserved | Reserved | Reserved | Reserved | Reserved | Reserved | Reserved | Reserved |
| | 0198H | | | | | | | | |
| 52 | 01A0H | Reserved | Unused | Unused | Unused | Unused | Unused | Unused | Unused |
| 53-58 | 01A8H- | Unused | Unused | Unused | Unused | Unused | Unused | Unused | Unused |
| | O1D0H | | | | | | | | |
| 59 | 01D8H | Unused | Unused | HSI | HSI | Blower Delay | Blower | Fan Speed | Fan |
| | | | | Programmed | Programmed | Programmed | Delay | Programmed | Speed |
| | | | | Value | Value | Value | Programmed | Speed | Programmed |
| | | | | | Backup | | Value | | Speed |
| | | | | | | | Backup | | Backup |
| 60 | 01E0H | Modbus | Modbus | Modbus | Modbus | EE Config | EE Config | EE Config | EE Config |
| | | Slave | Slave | Slave | Slave | Byte | Byte | Byte | Byte |
| | | Address | Address | Address | Address | | Compliment | Backup | Compliment |
| | | | Compliment | Backup | Compliment | | | | Backup |
| | | | | | Backup | | | | |
| 61 | 01E8H | EE Location | EE Location | EE Location | EE Location | EE Location | EE Location | EE Location | EE Location |
| | | Counter | Counter | Counter MSB | Counter MSB | Counter LSB | Counter LSB | Counter LSB | Counter LSB |
| | | MSB | MSB | Backup | Compliment | | Compliment | Backup | Compliment |
| | | | Compliment | | Backup | | | | Backup |
| 62 | 01F0H | Error Code | Error Code | Error | Error Code | Running | Running | Running | Running |
| | | Mask | Mask | Code | Mask | Timer 3^{rd} | Timer 3^{rd} | Timer 3^{rd} | Timer 3^{rd} |
| | | | Compliment | Mask | Compliment | Bytes | Bytes | Bytes | Bytes |
| | | | | Backup | Backup | | Compliment | Backup | Compliment |
| | | | | | | | | | Backup |
| 63 | 01F8H | Running | Running | Running | Running | K_EE_INIT_{—} | K_EE_INIT_{—} | K_EE_INIT_{—} | K_EE_INIT_{—} |
| | | Timer 2^{nd} | Timer 2^{nd} | Timer 2^{nd} | Timer 2^{nd} | VALUE | VALUE | VALUE | VALUE |
| | | Bytes | Bytes | Bytes Backup | Bytes | | Compliment | Backup | Compliment |
| | | | Compliment | | Compliment | | | | Backup |
| | | | | | Backup | | | | |

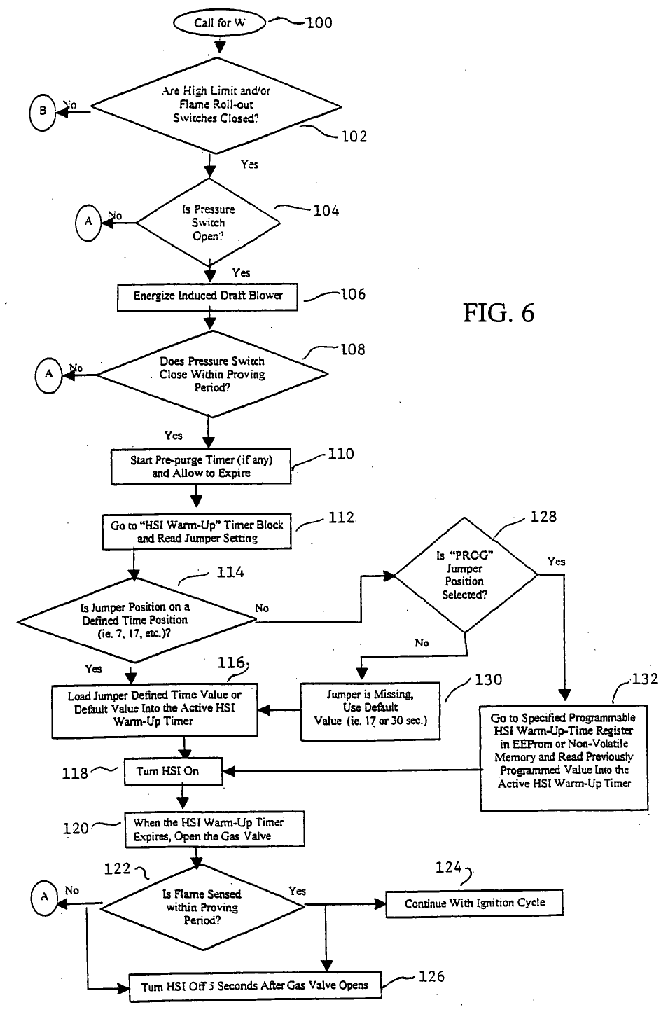

With reference to FIGS. 6, 7 and 9, the sequence of operation of the control in which error conditions are identified and stored along with their associated time stamps is shown.

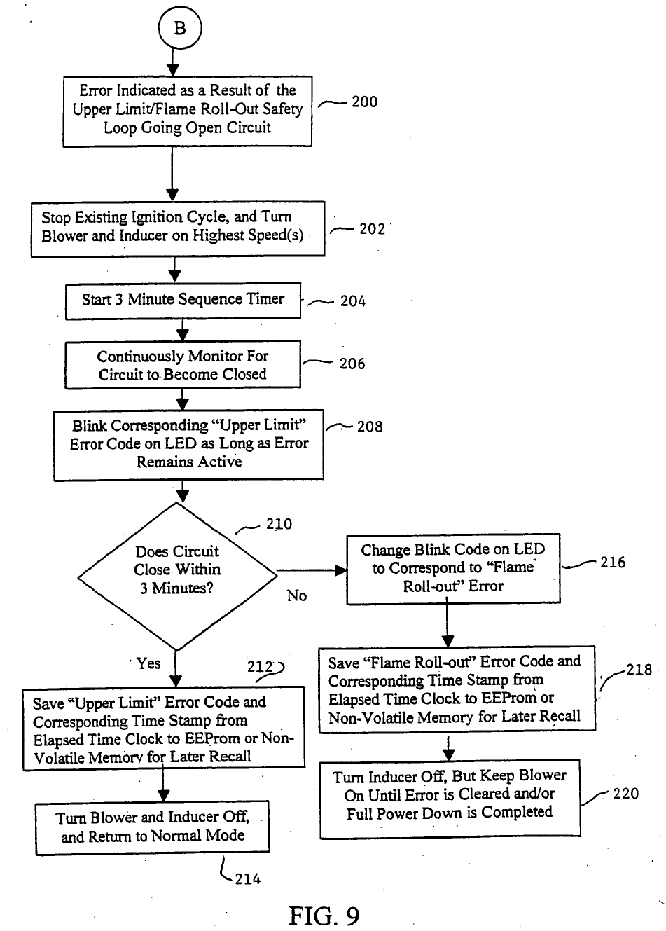

At 100, a thermostat input signal W for heat is followed by decision step 102 to determine if high limit and/or flame roll-out switches 40, 42, respectively, are closed. Upon a negative decision sub-routine B, FIG. 9, is entered and at process step 200 an error is indicated as a result of the upper limit/flame roll-out safely loop going open circuit. At process step 202 the existing ignition cycle is stopped and the blower 21 and induced draft motor 44 are turned on highest speeds. At step 204 a three minute sequence timer is initiated and at step 206 the circuit is continuously monitored for it to become closed. At step 208 an error code indication of “Upper Limit” is provided on LED 9 as long as the error remains active. Decision block 210 looks to see if the circuit closes within 3 minutes and, if so, process step 212 saves the “Upper Limit” error code and corresponding time stamp from elapsed time clock 5 to non-volatile memory 11 (or EEPROM 10 if used) for later recall. This is followed by step 214 at which blower 21 and induced draft 44 motors are turned off and the sequence returning to the normal mode. If the circuit does not close within 3 minutes at decision step 210 then at step 216 the error code on LED 9 is changed to that of flame roll-out error. The flame roll-out error is saved at step 218 along with the corresponding time stamp from elapsed time clock 5 to non-volatile memory 11, or EEPROM 10 if used, for later recall. At step 220 the induced draft motor 44 is turned off but the blower motor 21 is kept on until the error is cleared and/or full power down is completed.

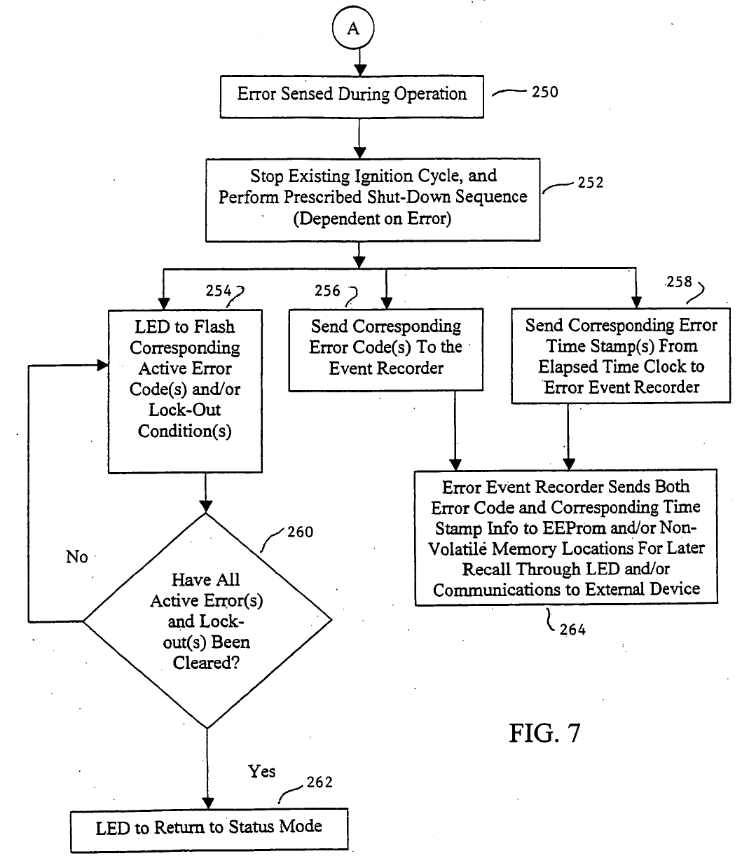

Going back to decision step 102 in FIG. 6, if the high limit and/or flame roll-out switches are closed the routine goes to decision step 104 which looks to see if the pressure switch 43 is open. If the pressure switch is closed then subroutine A, FIG. 7, is entered. An error is sensed at process step 250 and at step 252 the existing ignition cycle is terminated and a prescribed shut-down sequence, dependent on the specific error, is initiated. The subroutine then goes to steps 254, 256 and 258. At step 254, the appropriate active error code and/or lock-out condition is flashed on LED 9 and then decision step 260 looks to see if all active errors and lock-outs have been cleared. A negative response causes the routine to cycle back to step 254 and a positive response leads to step 262 at which LED 9 returns to flash the normal status mode (e.g., a continuous green heart-beat of 2 seconds on/2 seconds off).

Step 256 involves sending corresponding error codes to the event recorder 6 and step 258 involves sending the corresponding error time stamps from elapsed time clock 5 to the error event recorder and then at 264 the error event recorder sends both error code and corresponding time stamp to non-volatile memory 11, or EEPROM 10 if used, for later recall through LED 9 and/or communications, via interface H4.

Going back to decision step 104, FIG. 6, if the pressure switch is open then at step 106 the induced draft blower motor 44 is energized and then decision step 108 looks to see if pressure switch 43 closes within the proving period; if not, sub-routine A, FIG. 7, is re-entered and if it does close within the period, the pre-purge timer (if any) is started at step 110 and allowed to expire. The routine then goes to step 112 at which the jumper setting of HSI warm-up timer block H3 is read. Decision block 114 looks to see whether the jumper position is at one of the defined positions, that is, a position other than the Program position. Following an affirmative decision, then the routine goes on to step 116 at which the jumper defined time value is loaded into the active HSI warm-up timer. At step 118 the HSI is turned on and then at step 120, when the HSI warm-up timer has expired, the gas valve 14 is turned on. Decision step 122 then determines whether flame is sensed within the proving period and if so, at step 124 the routine continues on with the ignition cycle and the HSI igniter is turned off 5 seconds after the gas valve opens at step 126. If flame is not sensed within the proving period, step 122, the routine goes into sub-routine A, FIG. 7, once again as well as step 126 of turning HSI off seconds after the gas valve opens.

If the jumper position is not on a defined time position at step 114 then decision step 128 looks to see if the program jumper position has been selected. If not, the jumper is missing and the default value of 17 or 30 second is used at step 130 which goes on to step 116 at which the default value is loaded into the HSI timer. If the program jumper position has been selected at decision step 128 then the routine goes on to step 132 and a specified programmable HSI warm-up register in non-volatile memory, or EEPROM if used, and the previously programmed value is read into the active HSI warm-up timer and then the routine goes on to step 118 at which the HSI igniter is turned on.

With reference to FIG. 3, microprocessor 2 used in the described embodiment is model ATMEGA8515 manufactured by ATMEL Corporation, a forty pin device used as follows. Pins 1 and 2 are used to power and control the color of LED 9. At pin 3 a 2.5V reference is provided for an analog comparator used for flame sense. Pin 4 receives the FLAME SENSE input from the flame sense circuit used to ensure that flame is sensed when it should be in order to maintain the gas valve energized or to run a safety routine if flame is sensed when it should not be. Pin 5, MV IN, is an input from the gas valve used to ensure that the gas valve is on only when it should be within the ignition cycle. If it is sensed on at any other time, an error will result and a safety routine will run. Pin 6, PS IN, is an input from the pressure switch. The pressure switch should be open before the induced draft fan motor is turned on, but then close soon after the induced draft fan is energized. Improper inputs will result in error codes. Pin 7, LIMIT IN, is an input from the high thermal limit (or the high thermal limit and roll-out sensors when these are connected in series, as in the FIG. 1 schematic). If the limit and/or sensors go open circuit then an error code will result. Pin 8 is not used. Pin 9 is a reset input from a low voltage circuit which will reset the microprocessor if the 24 VAC input power falls below approximately 16 VAC. Pins 10 and 11 are inputs to receive data from the communications interface H4. Pin 12, 60 HZ IRQ is the 60 HZ interrupt to the control. Most of the timing of the control is derived from this signal. All inputs are read synchronously to this signal. Pin 13 is empty. Pins 14 and 15 provide status input to the communication interface H4. Pin 16 is empty. Pin 17, FLAME TEST, is an outgoing signal used to test that the flame is working properly to ensure that a false signal is not being generated. Pins 18 and 19 are empty and pin 20, GND, is a connection to earth ground. Pin 21, MVI DRV, is an output to the gas valve relay drive (not shown) which will ultimately switch power on to the gas valve through a relay. Pin 22, HSI DRV, is an output to the hot surface igniter relay drive (not shown) which will ultimately switch power on to the HSI through a relay. Pin 23, IDM DRV, is an output to the induced draft fan motor relay driver (not shown) which will ultimately switch power on to the IDM through a relay. Pin 24, FAN DRV, is an output to the main blower fan relay driver (not shown) which will ultimately switch line voltage through a relay to the blower through additional speed relays. Pin 25, HEAT COOL DRV, is an output to a relay driver (not shown) in which a speed relay will determine whether the heat motor tap 28 is energized or if power will flow to a secondary cool speed relay. Pin 26, COOL HILO DRIV, is an output to a relay drive (not shown) in which a secondary speed relay will determine whether the hi cool 27 or the lo cool 26 motor tap is energized. Pin 27, TWN DRV, is a drive signal for the twinning circuit which allows the blower fan motors of two furnaces connected together using a single wire to be synchronized. Pins 28 and 29 are empty. Pin 30 is an input from HSI warm-up selection block H3. Pin 31 is an input signal from the twinning circuit. Pin 32 is an input from last error switch 12. Pin 33 is an input from continuous fan speed selection block H2. Pin 34 is an input from the heat blower off delay selection block H1. Pin 35, G IN, is an input from G, or fan, terminal of the low voltage indoor thermostat (not shown). Pin 36, RO IN, is an input from the roll-out sensor(s). If the limit and/or sensors go open circuit then an error code will result. Note that although in this embodiment the roll-out sensors have their own separate input to the microprocessor, these sensors could share the same common input (pin 7) as the high thermal limit in order to save wiring costs between the sensors and the control board in the furnace, to save I/O on the microprocessor for additional desired features/inputs or to use a smaller, less expensive microprocessor containing a reduced number of I/O pins. Pin 37, W IN, is an input from W, or heat, terminal of the low voltage indoor thermostat. Pin 38, Y2 IN is an input from Y/Y2 (single only cooling/2nd stage cooling in a two stage system) terminal of the low voltage indoor thermostat, Pin 39, Y1 IN, is an input from Y1 (or 1st stage cooling in a two stage system) terminal of the low voltage indoor thermostat, and finally pin 40 is used for vcc, 5 volt AC to power the microprocessor.

As noted in the FIG. 6 routine and shown in FIGS. 1 and 3, control board 8a is provided with HSI warm-up timer block H3 which enables one to select different igniter parameters by the simple change of a jumper position to allow a choice to be made between a plurality of possible igniters, including warm-up times, material types, voltages and the like. A separate position is provided for programmable values, identified in FIGS. 1 and 3 as PROG. When the jumper is placed in this position as shown in FIG. 1 the OEM or a knowledgeable technician can utilize the communications interface H4 and an external device (laptop, PDA, or other comparable device) in order to place the desired programmable parameter into non-volatile memory 11 or EEPROM 10 if such is used. When left, or placed in the PROG position during operation, the HSI warm-up time would equal the previously programmed value, prior to opening the gas valve 14. Again, this programmable feature could be enabled to trigger an additional warm-up time, as a means to adjust parameters required to switch from silicon carbide to silicon nitride or some other igniter material, or the like. Although a jumper block has been shown and described, it is within the purview of the invention to use other comparable selection mechanisms such as a dip-switch.

According to the invention, reasonable programmable parameter limits to the programmable setting of block H3 can be fixed. For example, between 0.5 and 45 seconds. These fixed limits would be determined in part by the furnace manufacturer and/or igniter manufacturers, and would help prevent an incorrect programmable limit from being accidentally programmed into the non-volatile memory 11 location, which might otherwise create a no ignition error condition, or a premature end of life condition with the igniter 13.

Also shown in FIGS. 1 and 3 is fan speed jumper block H2 which enables the selection of one of a plurality of existing motor speed taps 22, 23, 24, 25 of main blower 21. As shown in FIG. 1, motor taps 22-25 are connected respectively to LO COOL 26, HI COOL 27, HEAT 28, and PARK 29 quick connect terminals of the control board. The PARK terminals 29 and 30 are dummy terminals used to plug unused motor tap wires to avoid loose, hanging wires in the furnace. When in heat mode, a call for heating by the wall thermostat would switch 24 VAC from the terminal 18 to the terminal 31, and once the heat exchanger was pre-heated, the main blower motor 21 would be energized through a combination of motor speed selection relays K1, K2, K3 such that line voltage coming in on L1 would be switched to the HEAT quick connect terminal 28 of the control board 8a, which would energize the connected motor tap 25 to provide the appropriate motor speed.

If the gas furnace has a cooling evaporator connected with a single stage compressor for air conditioning, then in cool mode, a call for cooling by the wall thermostat would switch 24 VAC from the terminal 18 to the Y/Y2 terminal 36. At an appropriate time, the main blower motor would be energized through a combination of motor speed selection relays K1, K2, K3 such that line voltage coming in on L1 would be switched to the HI COOL quick connect terminal 27 of the control board 8a, which would energize the connected motor tap 24 to provide the appropriate motor speed. If a two stage compressor was connected to the system, then the above would hold true, and in addition, a call for low or first stage cooling would switch 24 VAC from the terminal 18 to the Y1 terminal 37. At an appropriate time, the main blower motor would be energized through a combination of motor speed selection relays K1, K2, K3 such that line voltage coming in on L1 would be switched to the LO COOL quick connect terminal 26 of the control board which would energize the connected motor tap 23 to provide the appropriate motor speed.

In accordance with the invention, if G terminal 19 is energized by itself (placement of the wall thermostat fan switch to ON), then instead of turning on a single pre-selected blower speed, the installer or home/business owner has the option to direct blower motor power to any of the available motor tap speeds that are connected to the LO COOL 26, HI COOL 27, or HEAT 28 quick connects as shown on control board 8a. In the above example, one of three different blower speeds could be selected as the fan ON speed.

According to a feature of the invention, a separate programmable jumper position 38, identified as a PROG setting, is provided. When the PROG jumper setting is chosen, then the OEM could automatically set a particular fan speed default at the end of their manufacturing line through the communications interface H4 by using an external device (laptop, PDA, or other comparable device). This would allow a default fan speed position to be set for a particular application without the need to physically move the jumper to the desired HI COOL 27, HEAT 28, or LO COOL 26 positions. Then, with the wall thermostat fan ON setting, and the control board 8a fan speed jumper setting on PROG as shown in the drawing, the main blower would run at the programmed setting. Or it might also be useful to the occupants of the conditioned space; as when in the PROG setting 38, they could set the particular blower motor speed that they desire for the upcoming season through communications interface with the control board by using an external device (laptop, PDA, communicating thermostat, or other comparable device) without having to physically change the position of the selector, if different blower motor speed settings are desired for different seasons. As in the case of jumper block H3 previously discussed, it is within the purview of the invention to use other comparable selection means such as a dip switch.

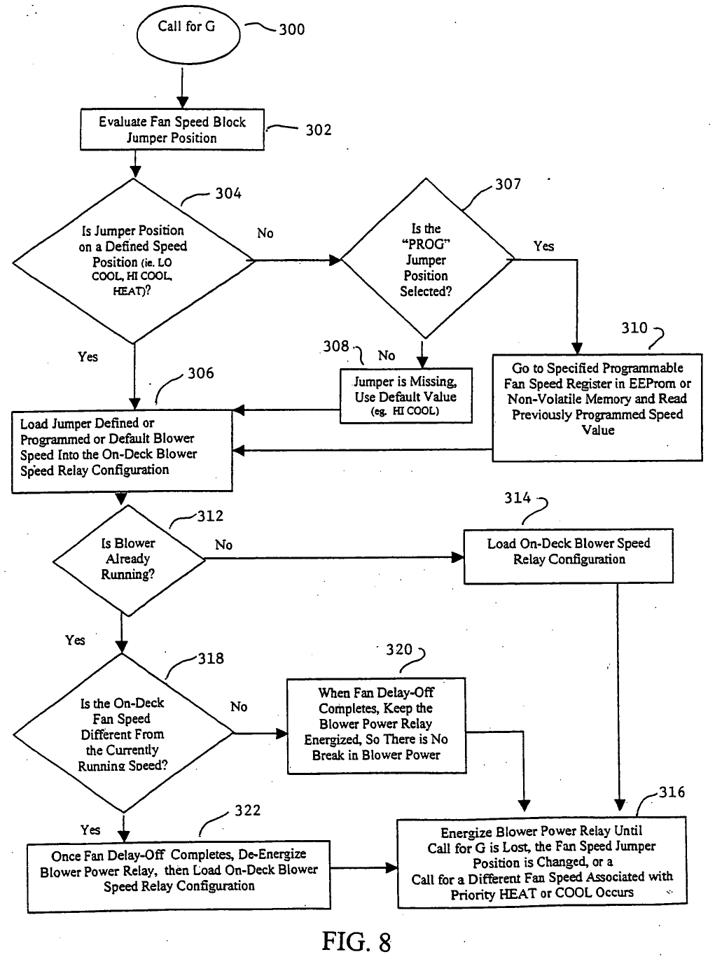

FIG. 8 shows the operating sequence used in accordance with the invention for the fan speed block H2 having the programmable position starting with a call for G, or fan, at 300. Upon energization of the G terminal by itself, the manual fan signal, the jumper position of the fan speed block H2 is evaluated at 302 and then at decision block 304 it is determined whether the jumper position is on a defined speed position, i.e., LO COOL, HI COOL or HEAT. If it is on a defined speed position, then at process step 306 the jumper defined speed value is loaded into the blower speed relay configuration. If the jumper position is not on a defined speed then the routine goes to decision step 307 to see if the PROG jumper has been selected. If not, then the jumper is missing and the default speed value, e.g., HI COOL, is used at step 308 and at step 306 is loaded into the blower speed relay configuration. If decision step 307 finds that the PROG jumper has been selected then at step 310 the fan speed register in non-volatile memory is read for the previously programmed speed value and is sent to step 306 and loaded into the blower speed relay configuration. Following step 306, decision step 312 looks to see if the blower motor 21 is already running. If it is not already running, then at step 314 the blower speed relay configuration is loaded and at step 316 the blower power relay is energized until the G signal is lost, the fan speed jumper position is changed or a call for a different speed associated with a higher priority heat or cool operation occurs.

If the blower motor is already running, step 312, then the routine goes on to decision step 318 which determines if the on-deck fan speed, i.e., the speed value of step 306, is different from the currently running speed. If not, then at step 320 when the fan delay-off is completed, the blower power relay remains energized with no break in blower power and the routine goes on to step 316. If the on-deck fan speed is different from the currently running speed at decision step 318 then the routine goes to step 322 and once the fan delay-off is completed, the blower power relay is de-energized and then the on-deck blower speed relay configuration is loaded and the routine goes into step 316.

Time of the blower delay, mentioned in the description of FIG. 8, is controlled by blower delay jumper block H1 shown in FIGS. 1 and 3. The jumper block provides selectable off time values relating to 60, 90 and 120 seconds. A programmable position identified as PROG is also included in block H1. When the PROG setting is chosen, the OEM or a knowledgeable technician can utilize the communications interface H4 and an external device (laptop, PDA, or other comparable device) in order to place the desired programmable value into non-volatile memory. The use of this PROG setting for blower delays may be limited to a single blower delay-off selection for heating, and/or any other OEM desired blower delays including blower delay-off for cooling or fan, and/or blower delay-on for heating, cooling or fan conditions (not shown in FIGS. 1 and 3). Depending on the OEM desired blower delays, if the heating, cooling, or fan cycle running had one of these selectable blower delays implemented, and the jumper was in the PROG position, then the blower on-delay or blower off-delay would either turn on or off in accordance with the programmed non-volatile memory location value.

If desired, fixed reasonable programmable parameter limits can be added to PROG position choices. In other words, if the furnace manufacturer desired to have a programmable setting for blower on-delay in the heating mode, a reasonable PROG setting might be 15 to 45 seconds, because if the blower turned on prior to 15 seconds there would always be cold air blowing into the occupied space whereas if the blower did not come on before 45 seconds, then the over temperature limit switch 40 next to the heat exchanger might trip and limit the ability for normal furnace operation. These fixed limits would be determined by the furnace manufacturer, and would help prevent an incorrect programmable limit from being accidentally programmed into the non-volatile memory which might otherwise create an uncomfortable or error condition.

If desired, a default value to be set in the blower delay PROG setting so that if the jumper is moved to that position on the control board, and the OEM or knowledgeable technicians have not entered a value into the non-volatile memory location, the furnace will still function normally with a reasonable default value in that memory location.

A high limit thermostat 40 can trip to the open state for a number of reasons including; blockage of air flow in the return or supply ducts, broken blower motor 21 or start capacitor, or loss of power at some point in the heating cycle, just to name a few. Once the high limit thermostat 40 cools down to the reset temperature (typically 20 to 30 degrees C. below the trip temperature), then the control 8 will typically consider the system to be back to a safe condition, and a normal ignition will be permitted again.

A flame roll-out 42 switch can trip to the open state as the result of various conditions, such as corroded burner nozzles, back drafts or quick pressure variations in the combustion chamber area, just to name a few. The use of manual reset thermostats for flame roll-out 42 ensures that this very un-safe condition will not be repeated until human intervention (resetting of the thermostat) takes place. This effectively puts the system into a hard lock-out condition. Post shut-down typically involves running the induced draft fan motor 44 for some period of time to help expel any combustible gases remaining in the furnace cabinet and/or heat exchanger, and leaving the blower motor 21 on, the resulting constant flow of cold air being a signal to the homeowner or business owner that something is wrong, such that a service call is made.

In one such system shown in FIG. 1, where the high limit 40 and flame roll-out limits 42 are connected in series, the following manipulation of inputs into the control board 8a provides separate and distinct error codes.

If the high limit thermostat 40 trips during an ignition cycle, the gas valve 14 automatically opens, and the ignition process is stopped immediately, while the induced draft motor 44 and main blower motor 21 will continue to operate.

This will over a certain period of time (say 1½ minutes) remove enough heat from the system to reset the high limit thermostat 40, at which point a normal ignition sequence will be allowed to start again. As stated above, a flame roll-out switch 42 will never reset without human intervention, therefore, if an open circuit occurs with multiple sensors in series, then as discussed above in explaining the flow chart of FIG. 9 (routine B), in accordance with the invention, LED 9 is energized to flash with an error code corresponding to the more common thermal limit failure first, (but is not saved to non-volatile memory at that time). The control continues to wait and monitor for the reset of the open circuit. Since it can be assumed that a high limit switch 40 will absolutely reset with some safety factor, say by 3 minutes, then this is used as the time criteria with which to judge the error code. Therefore, if in this example, no reset has occurred within 3 minutes, then the error code is changed to that of a flame roll-out 42, the flame roll-out error code is then stored in non-volatile memory, and the desired post shut-down protocol for flame roll-out is performed. On the other hand, if reset of the open circuit occurs before the end of the 3 minute timer (in our example), then at the point of reset, the error code and corresponding time stamp for high limit is stored in non-volatile memory, and any post shut-down protocol desired for high limit trip performed prior to allowing normal ignition to begin again.

If desired, this arrangement can be modified to include waiting to flash an error code on the status LED 9 until after the reset or 3 minute period ends, or storing a high limit error initially in non-volatile memory, and only changing it if reset does not occur within the 3 minute period (to prevent the error from not getting recorded, should a power failure occur within the 3 minute period), or similar combinations that anyone involved in the skill and art of furnace control and software manipulation would be familiar with.

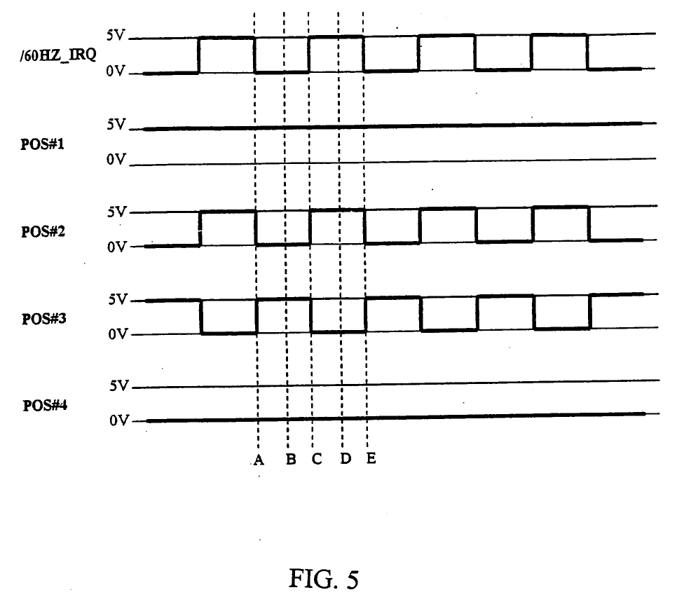

In accordance with the invention, the position of the jumper in each of jumper blocks H1, H2 and H3 is determined using only a single digital input on the microprocessor for each block rather than using a conventional, more costly analog-to-digital converter. With reference to the schematic of FIG. 4 and the timing diagram of FIG. 5, jumper block H1 is shown having four positions, Pos. Nos. 1-4.

The control is powered by 24 VAC, 60 HZ, signals R and C, rectified through a full wave diode bridge, D1-D4, filtered by capacitor C2, and regulated by resistor R6 and zener diode D5 to create the 5V power for the microcontroller. The R signal is fed through a filtering network, R4 and C1, and a current limiting resistor, R5, into the microcontroller's interrupt input pin. This input signal 60 HZ_IRQ, is shown on the top line of the timing diagram. All inputs to the microcontroller are read synchronous to this IRQ signal, which generates an interrupt to the microcontroller at point A in the timing diagram. The inputs are read by the microcontroller at points B and D in the timing diagram on each cycle of the 60 Hz input.

Since the microcontroller's 5V power supply is referenced to GND connection point of the diode bridge, at the jumper block input to the microprocessor, the R and C signals look like 60 Hz square waves than are 180 degrees out of phase.

With reference to FIG. 5, if the microprocessor reads a high on the jumper block input at points B and D, it knows that the jumper is in POS#1. If the input is low at point B but high at point D, it knows that the jumper is in POS#2. If the input is high at point B but low at point D, it knows that the jumper is in POS#3. If the signal is low at points B and D, it knows that the jumper is either in POS#4 or missing.

Thus in accordance with the invention, the microcontroller can distinguish one of four jumper positions using only one low cost general I/O pin.

Although the invention has been described with regard to specific preferred embodiments thereof, variations and modifications will become apparent to those skilled in the art. It is therefore the intention that the appended claims be interpreted as broadly as possible in view of the prior art to include all such variations and modifications.

What is claimed:

1. In a gas furnace system having an ignition control having a microprocessor, an igniter, an induced draft fan motor, a blower fan motor, a gas valve and safety and monitoring devices, the method comprising the steps of:
assigning a unique code for each of a selected number of cautionary and operational error conditions,
sensing an error condition during operation of the furnace as an error event,
displaying a corresponding error code and utilizing an elapsed time clock, generating a time stamp for each error event,
sending the error event and corresponding time stamp to an event recorder, and
storing the event and corresponding time stamp in a non-volatile memory location.

2. The method of claim 1 further comprising the step of recalling at least the most recent stored error events and corresponding time stamps.

3. The method of claim 2 further comprising the step of storing up to n number of error events at any given time.

4. The method of claim 3 further comprising the step of incrementing the time clock once a minute while the time clock is powered for the expected life of the control.

5. The method of claim 4 in which the expected life of the control is 30 years.

6. The method of claim 3 in which n equals 16.

7. The method of claim 1 in which the non-volatile memory location is in the microprocessor.

8. The method of claim 1 in which the non-volatile memory location is in a separate EEPROM component.
